(19) United States
(12) Patent Application Publication
(10) Pub. No.: US 2018/0126786 A1
(43) Pub. Date: May 10, 2018

(54) PNEUMATIC TIRE

(71) Applicant: TOYO TIRE & RUBBER CO., LTD., Itami-shi (JP)

(72) Inventor: Harunobu Suita, Itami-shi (JP)

(73) Assignee: TOYO TIRE & RUBBER CO., LTD., Itami-shi (JP)

(21) Appl. No.: 15/671,322

(22) Filed: Aug. 8, 2017

(30) Foreign Application Priority Data
Nov. 8, 2016 (JP) 2016-217874

(51) Int. Cl. B60C 9/20; B60C 9/02; B60C 9/08; B60C 11/03; B60C 15/024; B32B 25/04

(52) U.S. Cl. CPC B60C 9/2006; B60C 9/0292; B60C 9/08; B60C 11/03; B60C 2011/0372; B32B 25/04; B60C 2009/2016; B60C 2011/0386; B60C 15/024

(57) ABSTRACT

A tire has a carcass, four belt plies, a tread rubber, a plurality of main grooves and a rib. The plurality of main grooves and the rib being formed on a surface of the tread rubber. The cords of second and third belt plies of the four belt plies from the carcass toward the outer periphery are inclined in an opposite direction to each other relative to a tire axis, and are intersected with each other. An angle of incline of the cords of the second and third belt plies relative to the tire peripheral direction is smaller at an belt end than that at a tire equator. The angle of incline in a groove area overlapping the main grooves in plan view is greater than an angle of incline in rib areas at both sides of the groove area.

### BACKGROUND OF THE INVENTION

### Field of the Invention

The present disclosure relates to a pneumatic tire for heavy load in which a rib extending in a peripheral direction is formed in a tread.

### Description of the Related Art

A pneumatic tire for heavy load which is used in a track or a bus is a radial tire, and has a carcass including a steel cord that is arranged radially around a tire axis. Four belt plies having steel cords are laminated on an outer periphery of the carcass. A main groove extending in a tire peripheral direction is formed in a tread, and a rib sectioned by the main groove extends in the tire peripheral direction. The pneumatic tire for heavy load called as a rib tire is a tire in which only the rib is formed in the tread and which does not have any block divided in a peripheral direction.

A tire for heavy load is disclosed in JP-A-2006-205817, which describes that an angle in a main groove area is changed greater than the other angles with regard to only one belt ply, for suppressing a groove crack. It also describes that the angle in the main groove area is between 30 degrees and 45 degrees relative to the tire peripheral direction.

### SUMMARY OF THE INVENTION

However, the main groove angle is between 30 degrees and 45 degrees, which is large and is not realistic, and therefore the advantageous effect cannot be obtained.

A tire for heavy load is required to suppress a diameter growth at a shoulder portion, and to have groove crack resistance and uneven wear resistance.

The present disclose has been made by paying attention to the problem mentioned above. An object of the present disclosure is to provide a pneumatic tire which is improved in the suppression of a diameter growth at a shoulder portion, the groove crack resistance and the uneven wear resistance.

The present disclosure employs the following means for achieving the object.

In other words, according to the present disclosure, there is provided a pneumatic tire including a carcass; four belt plies which have cords and are laminated on an outer periphery of the carcass in a tread portion; a tread rubber; a plurality of main grooves which extend along a tire peripheral direction; and a rib which is sectioned by the main grooves and is continuously provided in the tire peripheral direction. The plurality of main grooves and the rib being formed on a surface of the tread rubber. The cords of second and third belt plies of the four belt plies from the carcass toward the outer periphery are inclined in an opposite direction to each other relative to a tire axis, and are intersected with each other. An angle of incline of the cords of the second and third belt plies relative to the tire peripheral direction is smaller at an belt end than that at a tire equator. The angle of incline in a groove area overlapping the main grooves in plan view is greater than that of incline in rib areas at both sides of the groove area.

As mentioned above, the second and third belt plies are the main belts which are intersected with each other, while being inclined in the opposite directions to each other relative to the tire axis. The angle of incline of the cords of the main belts are smaller at the belt ends than that at the tire equator. Therefore, the binding achieved by the main belts is stronger in the shoulder portion than in the tire equator, and thus it is possible to suppress the growth in the diametrical direction of the shoulder portion.

On the other hand, if the angle of incline in the groove area overlapping the main groove in plan view becomes relatively smaller, the growth in the diametrical direction can be suppressed in the groove area, however, an opening and closing motion of the groove is brought about at the rolling time. Since the angle of incline in the groove area is made greater than the angle of incline in both sides, the force is dispersed into the growth in the diametrical direction without being concentrated on the opening and closing motion of the groove at the rolling time. As a result, it is possible to improve the groove crack resistance and the uneven wear resistance.

Thus, it is possible to suppress the growth in the diametrical direction of the shoulder portion, while improving the groove crack resistance and the uneven wear resistance.

### BRIEF DESCRIPTION OF THE DRAWINGS

FIG. 1 is a view showing a relationship between a tread shape and a cord angle of a belt according to an embodiment of the present disclosure;

FIG. 2 is a view showing a relationship between a tread shape and a cord angle of a third belt in Example 1;

FIG. 3 is a view showing a relationship between a tread shape and a cord angle of a third belt in Example 2;

FIG. 4 is a view showing a relationship between a tread shape and a cord angle of a third belt in Comparative Example 1; and

FIG. 5 is a view showing a relationship between a tread shape and a cord angle of a third belt in Comparative Example 2.

### DETAILED DESCRIPTION OF THE PREFERRED EMBODIMENT

A description will be given below of a pneumatic tire according to an embodiment of the present disclosure with reference to the accompanying drawings.

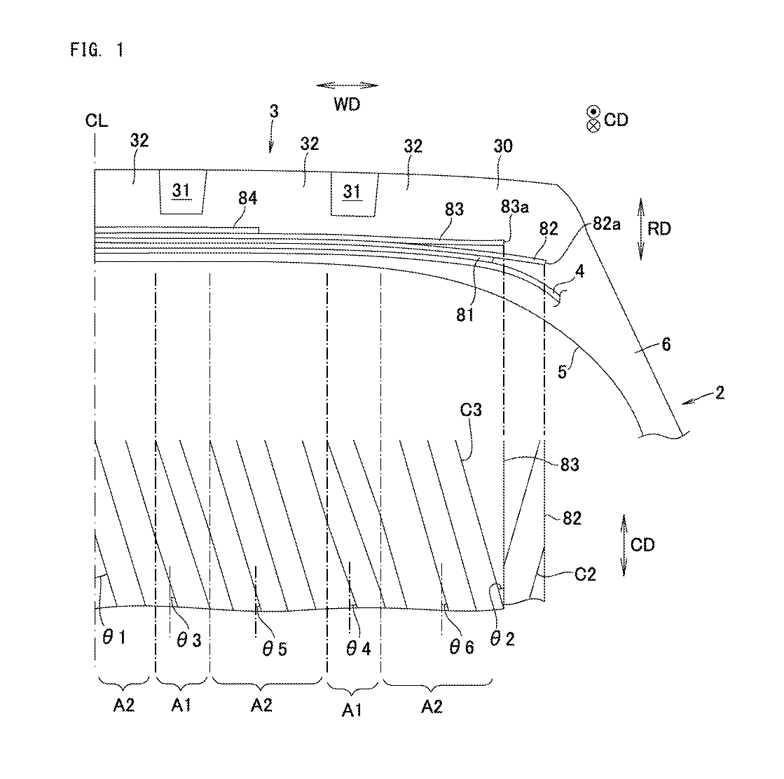

As shown in FIG. 1, the pneumatic tire is provided with a pair of bead portions (not shown), side wall portions 2 which extend to an outer side in a tire radial direction RD from the respective bead portions, and a tread portion 3 which is connected to outer ends of both the side wall portions 2 in the tire radial direction RD. The bead portion has an annular bead core which is formed by rubber-coating a converged body such as a steel wire, and a bead filler which is formed by a hard rubber.

Further, the tire is provided with a toroidal carcass 4 which gets to the bead portion from the tread portion 3 via the side wall portions 2. The carcass 4 is provided between a pair of bead portions, and is wound up its end portion to the bead core. The carcass 4 has a steel cord which radially extends around an axis of the tire, and a topping rubber which coats the steel cord. The steel cord is along a tire meridian cross section. An inner liner rubber 5 for retaining a pneumatic pressure is arranged at an inner side of the carcass.

A side wall rubber 6 is provided at an outer side of the carcass 4 in the side wall portion 2. Further, a rim strip rubber (not shown) coming into contact with a rim (not shown) when being installed to the rim is provided at the outer side of the carcass 4 in the bead portion.

Four belt plies 81, 82, 83 and 84 for reinforcing the carcass 4 and a tread rubber 30 are provided on an outer periphery of the carcass 4 in the tread portion 3 sequentially from an inner side toward an outer side. A plurality of main grooves 31 and a rib 32 are formed on a surface of the tread portion 3. The main grooves 31 extend along a tire peripheral direction CD, and the rib 32 is sectioned by the main grooves 31 and is continuous in the tire peripheral direction CD. In the present embodiment, any block divided in the tire peripheral direction CD is not formed because the rim tire is used. In the present embodiment, two main grooves 31 are formed at one side of the tire, and four main grooves 31 are provided as a whole, but the structure is not limited thereto. For example, three main grooves may be provided as a whole, or five or more main grooves may be provided as a whole.

The four belt plies 81, 82, 83 and 84 include a plurality of steel cords arranged in parallel like a bamboo blind, and are formed by coating the steel cords with rubber. The cords C2 and C3 of the belt plies 82 and 83, which are the second and the third of four belt plies 81, 82, 83 and 84 from the carcass 4 toward the outer periphery, are inclined in the opposite direction to each other relative to the tire axis to be intersected with each other. The second and third belt plies 82 and 83 are so-called main belts, and interpose the tread rubber 30.

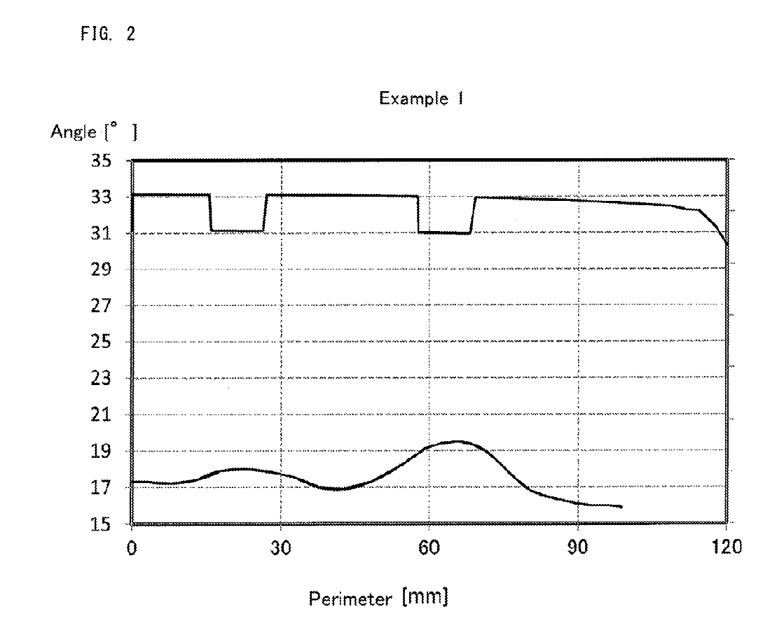

FIG. 2 is a graph showing a tread shape, and an angle of incline of the cord of the third belt ply 83 relative to the tire peripheral direction CD. As to the angle of incline of the second and third belt plies 82 and 83 relative to the tire peripheral direction CD, an angle θ2 of belt ends 82a and 83a is smaller than an angle θ1 of the tire equator CL, as shown in FIGS. 1 and 2.

An angle θ3 of incline in a groove area A1 overlapping the main groove 31 in plan view is greater than the angles θ1 and θ5 in a rib area A2 at both sides of the groove area A1. An angle θ4 of incline in the groove area A1 is greater than the angles θ5 and θ6 of incline in the rib area A2 at both sides of the groove area A1.

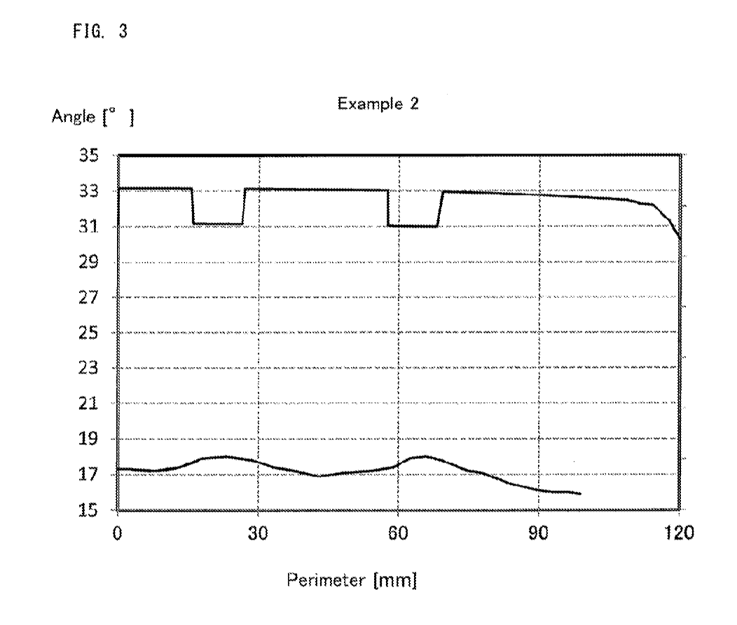

Further, as shown in FIG. 2, the angles θ3 and θ4 of incline in the groove area A1 satisfy the relationship of θ3<θ4, and become greater from the tire equator side toward the outer side in the tire width direction. As a matter of course, as shown in FIG. 3, the angle θ3 of incline in the groove area A1 at the tire equator side may be the same as the angle θ4 of incline in the groove area A1 at the outer side in the tire width direction.

The angles of incline of the cords of the second and third belt plies 82 and 83 are preferably between 15 and 25 degrees, and more preferably between 15 and 20 degrees. The angles of incline preferably change smoothly in such angle range. This is because a strain is concentrated when being bent. If the angle becomes too large, a diameter growth is enlarged since a binding force of the belt is weakened. As a result, a problem of uneven wear is generated due to an irregular ground shape and an uneven ground pressure. If the angle is too small, the binding force of the belt is strong, and the deformation of the tread surface at the grounding time is received only by the tread portion. As a result, the strain tends to be concentrated on the groove bottom, and the problem of the groove bottom crack resistance is generated.

As mentioned above, the pneumatic tire according to the present embodiment has a carcass 4; four belt plies 81, 82, 83 and 84 which have cords and are laminated on an outer periphery of the carcass 4 in a tread portion 3; a tread rubber 30; a plurality of main grooves 31 which extend along a tire peripheral direction CD; and a rib 32 which is sectioned by the main grooves 31 and is continuously provided in the tire peripheral direction CD. The plurality of main grooves 31 and the rib 32 being formed on a surface of the tread rubber 30. The cords C2 and C3 of second and third belt plies 82 and 83 of the four belt plies 81, 82, 83 and 84 from the carcass 4 toward the outer periphery are inclined in an opposite direction to each other relative to a tire axis, and are intersected with each other. An angle of incline of the cords of the second and third belt plies 82 and 83 relative to the tire peripheral direction CD is smaller at an belt end 82a and 83a than that at a tire equator CL. The angle θ3 (θ4) of incline in a groove area A1 overlapping the main grooves 31 in plan view is greater than an angle θ1 and θ5 (θ5 and θ6) of incline in rib areas A2 at both sides of the groove area A1.

As mentioned above, the second and third belt plies 82 and 83 are the main belts which are intersected with each other, while being inclined in the opposite directions to each other relative to the tire axis. The angle of incline of the cords of the main belts 82 and 83 are smaller at the belt ends 82a and 83a than that at the tire equator CL. Therefore, the binding achieved by the main belts 82 and 83 is stronger in the shoulder portion than in the tire equator CL, and thus it is possible to suppress the growth in the diametrical direction of the shoulder portion.

On the other hand, if the angle of incline in the groove area A1 overlapping the main groove 31 in plan view becomes relatively smaller, the growth in the diametrical direction can be suppressed in the groove area A1, however, an opening and closing motion of the groove is brought about at the rolling time. Since the angle θ3 (θ4) of incline in the groove area A1 is made greater than the angle θ1 and θ5 (θ5 and θ6) of incline in both sides, the force is dispersed into the growth in the diametrical direction without being concentrated on the opening and closing motion of the groove at the rolling time. As a result, it is possible to improve the groove crack resistance and the uneven wear resistance.

Thus, it is possible to suppress the growth in the diametrical direction of the shoulder portion, while improving the groove crack resistance and the uneven wear resistance.

According to the present embodiment, the angle θ3 and θ4 of incline in the groove area A1 satisfy the relationship of θ3<θ4, and becomes greater from a tire equator side toward an outer side in a tire width direction.

According to the structure, the angle of incline at the shoulder portion side having the great strain becomes large. Thus, it is possible to further improve the groove crack resistance and the uneven wear resistance.

### EXAMPLES

In order to specifically describe the structure and the effect of the present disclosure, the following evaluations were carried out in the following examples.

### (1) Diameter Growth

An inner diameter was measured in three states, i.e., rim close, brand new INF, and grown INF, under a condition of tire size 295/75R22.5, rim size 22.5×8.25 and pneumatic pressure 760 kPa, and an inner surface change amount at the grown INF time from the rim close was indexed. The result of Comparative Example 1 was set to 100. The smaller numerical value is preferable because the diameter growth is small.

### (2) Groove Bottom Crack Resistance

A drum test was executed under a condition of tire size 295/75R22.5, rim size 22.5×8.25, pneumatic pressure 760 kPa, speed 60 km/h and load 21.8 kN. The groove bottom crack width after traveling for 15000 km was measured, and the result of Comparative Example 1 was set to 100 so that the results were indexed. The larger numerical value is preferable because the groove bottom crack resistance can be obtained.

### (3) Uneven Wear Resistance

The tire having the tire size of 295/75R22.5 was assembled in the wheel having the rim size of 22.5×8.25 under the pneumatic pressure of 760 kPa (TRA standard internal pressure). The traveling test was executed under the condition of speed 80 km/h and load 27.5 kN (TRA 100% load), and a wear amount ratio according to the center (Ce) and shoulder (Sh) ribs was displayed. If Sh>Ce is established, Sh/Ce is a plus value and means a shoulder wear. If Ce>Sh is established, Ce/Sh is a minus value and means a center wear. If Sh=Ce is established, Ce/Sh is 1.0 and means an even wear. Accordingly, 1.0 is preferable.

### Example 1

The angle of incline of the cord C3 of the third belt ply 83 was set as shown in FIG. 2. The second belt ply 82 was inversion to the third belt ply. The angle θ1 of incline of the tire equator CL was set to be greater than the angle θ2 of incline of the belt end 83a. The angles θ3 and θ4 of incline in the groove area A1 were greater than in the adjacent rib area A2. The angle θ3 of incline in the groove area A2 at the equator side was set to be smaller than the angle θ4 of incline in the groove area A2 at the shoulder side.

### Example 2

The angle of incline of the cord C3 of the third belt ply 83 was set as shown in FIG. 3. The second belt ply 82 was inversion to the third belt ply. The angle θ3 in the groove area A1 at the equator side was set to be equal to the angle θ4 in the groove area A1 at the shoulder side. Except the above, the other was the same as in Example 1.

### Comparative Example 1

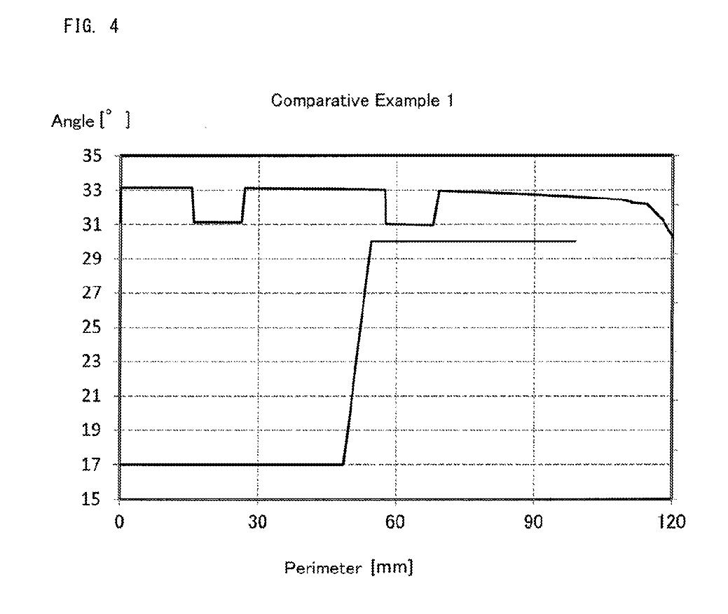

The angle of incline of the cord C3 of the third belt ply 83 was set as shown in FIG. 4. The second belt ply 82 was inversion to the third belt ply. The angle θ1 of incline of the tire equator CL was set to be smaller than the angle θ2 of incline of the belt end 83a.

### Comparative Example 2

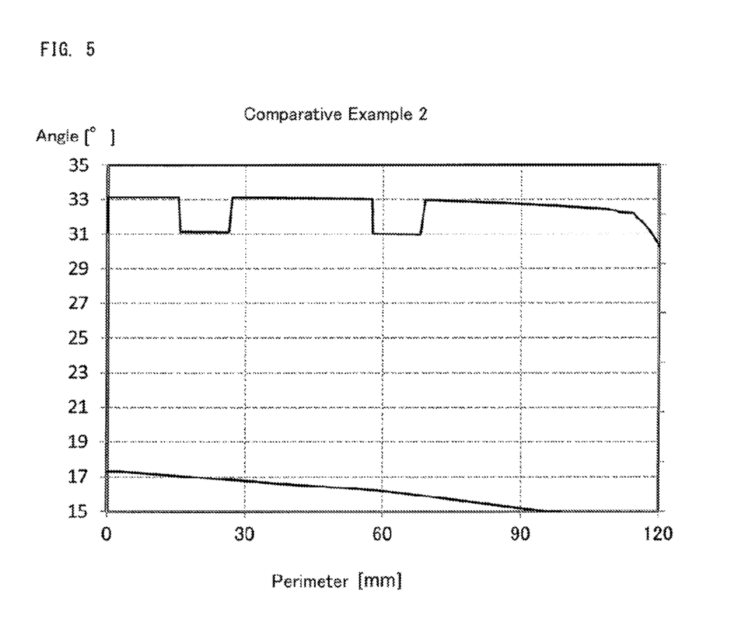

The angle of incline of the cord C3 of the third belt ply 83 was set as shown in FIG. 5. The second belt ply 82 was inversion to the third belt ply. The angle θ1 of incline of the tire equator CL was set to be greater than the angle θ2 of incline of the belt end 83a.

TABLE 1

| | Comparative | Comparative | | |
|---|---|---|---|---|
| | Example 1 | Example 2 | Example 1 | Example 2 |
| Cord angle | FIG. 4 | FIG. 5 | FIG. 2 | FIG. 3 |
| Diameter growth | 100 | 95 | 95 | 95 |
| Groove bottom | 100 | 90 | 110 | 105 |
| crack resistance | | | | |
| Uneven wear | 1.8 | 1.5 | 1.0 | 1.2 |
| resistance | | | | |

According to Table 1, the diameter growth in Comparative Example 2 is smaller than that in Comparative Example 1. It is considered that the growth in the diametrical direction was restricted in the belt end, that is, the shoulder portion, because the angle was smaller at the belt end than the angle at the tire equator CL as to the angle of incline of the cords of the second and third belt plies 82 and 83.

The groove bottom crack resistance in Comparative Example 2 is deteriorated as compared to that in Comparative Example 1. This is because, although the growth in the diametrical direction was suppressed due to the strong binding of the groove bottom portion, the opening and closing motion of the groove in the width direction was brought about.

The diameter growth, the groove bottom crack resistance and the uneven wear resistance in Examples 1 and 2 are improved as compared to those in Comparative Example 1. Since the angle at the belt end was smaller than the angle at the tire equator CL, the diameter growth was suppressed. Further, it is considered that, since the opening and closing motion of the groove in the width direction was suppressed by making the angle in the groove area A1 greater than that in its periphery, the groove bottom crack resistance and the uneven wear resistance were improved.

The reason why the groove bottom crack resistance and the uneven wear resistance in Example 2 was deteriorated as compared with those in Example 1 is considered that the all angles in the groove area A1 were set to be the same although the crack and the uneven wear tend to be generated more easily in the shoulder portion. Therefore, it can be understood that it is effective that the angle of incline in the groove area A1 is set to be greater from the tire equator side toward the belt end side (the outer side in the width direction).

The embodiment according to the present invention has been described above with reference to the accompanying drawings, however, it should be noted that the specific structures are not limited to this embodiment. The scope of the present invention is indicated by the claims in addition to the above description of the embodiment, and includes the equivalent to the claims and all the changes within the scope.

The structure employed in the embodiment mentioned above can be employed in any other optional embodiments. The specific structure of each of the portions is not limited only to the embodiment mentioned above, but can be variously modified within the range which does not deviate from the scope of the present disclosure.

What is claimed is:

1. A pneumatic tire comprising:
a carcass;
four belt plies which have cords and are laminated on an outer periphery of the carcass in a tread portion;
a tread rubber;
a plurality of main grooves which extend along a tire peripheral direction; and
a rib which is sectioned by the main grooves and is continuously provided in the tire peripheral direction, the plurality of main grooves and the rib being formed on a surface of the tread rubber, wherein
the cords of second and third belt plies of the four belt plies from the carcass toward the outer periphery are inclined in an opposite direction to each other relative to a tire axis, and are intersected with each other,
an angle of incline of the cords of the second and third belt plies relative to the tire peripheral direction is smaller at an belt end than that at a tire equator, and
the angle of incline in a groove area overlapping the main grooves in plan view is greater than that of incline in rib areas at both sides of the groove area.

2. The pneumatic tire according to claim 1, wherein the angle of incline in the groove area becomes greater from a tire equator side toward an outer side in a tire width direction.

3. The pneumatic tire according to claim 1, wherein the angle of incline of the cords of the second and third belt plies is between 15 and 25 degrees.

4. The pneumatic tire according to claim 1, wherein only the main grooves and the rib are formed in the tread rubber, and a block divided in a peripheral direction is not formed in the tread rubber.
